(19) United States
(12) Patent Application Publication
(10) Pub. No.: US 2026/0238896 A1
(43) Pub. Date: Aug. 13, 2026

(54) PHOTODETECTION ELEMENT AND ELECTRONIC APPARATUS

(71) Applicant: SONY SEMICONDUCTOR SOLUTIONS CORPORATION, KANAGAWA (JP)

(72) Inventors: TSUTOMU IMOTO, KANAGAWA (JP); REN HIYOSHI, KANAGAWA (JP); MANABU SUZUKI, KANAGAWA (JP); YUTO SHIMASAKI, KANAGAWA (JP)

(21) Appl. No.: 19/158,065

(22) PCT Filed: Feb. 5, 2024
(86) PCT No.: PCT/JP2024/003681

§ 371 Date: Aug. 20, 2025

(30) Foreign Application Priority Data
Mar. 9, 2023 (JP) 2023-036905

(51) Int. Cl. H04N 25/707; H04N 25/47

(52) U.S. Cl. CPC H04N 25/707; H04N 25/47

(57) ABSTRACT

Provided is a photodetection element that can improve uniformity of characteristics of each of an imaging pixel and an event detection pixel. A photodetection element according to one aspect of the present disclosure includes: an event detection pixel that outputs, on the basis of a photocurrent obtained by photoelectrically converting incident light, a detection signal indicating that a light amount of the incident light has changed; and an imaging pixel that is arranged adjacent to the event detection pixel and outputs a pixel signal corresponding to the light amount of the incident light on the basis of the photocurrent. Both the event detection pixel and the imaging pixel include a photoelectric conversion element that photoelectrically converts the incident light, a first pixel circuit that generates the detection signal, a second pixel circuit that generates the pixel signal, and a switching circuit that switches a circuit connected to the photoelectric conversion element to the first pixel circuit or the second pixel circuit.

### TECHNICAL FIELD

The present disclosure relates to a photodetection element and an electronic apparatus.

### BACKGROUND ART

There is known a photodetection element in which Event-based Vision Sensor (EVS) pixels (hereinafter, referred to as event detection pixels) and Intensity pixels (hereinafter, referred to as imaging pixels) are arranged adjacent to each other in the same pixel block. The event detection pixel outputs a detection signal indicating that a light amount of incident light has changed. On the other hand, the imaging pixel outputs a pixel signal corresponding to the light amount of incident light.

The photodetection element including the event detection pixel and the imaging pixel can acquire a captured image at the same time while performing event detection at high speed.

### CITATION LIST

### Patent Document

Patent Document 1: Japanese Patent Application Laid-Open No. 2021-197649

### SUMMARY OF THE INVENTION

### Problems to be Solved by the Invention

The configurations of the pixel circuits are different between the event detection pixel and the imaging pixel. Therefore, in a case where the pixel size and arrangement density of the imaging pixel and the event detection pixel are not the same, the periodicity of the pixel layout is impaired, and a slight difference occurs in the structure of the pixel depending on whether the adjacent pixel is the imaging pixel or the event detection pixel. In this case, there is a concern that the pixel characteristics change and the uniformity of the imaging characteristics deteriorates to degrade the image quality.

Therefore, the present disclosure provides a photodetection element and an electronic apparatus that can improve uniformity of characteristics of each of an imaging pixel and an event detection pixel.

### Solutions to Problems

A photodetection element according to one aspect of the present disclosure includes: an event detection pixel that outputs, on the basis of a photocurrent obtained by photoelectrically converting incident light, a detection signal indicating that a light amount of the incident light has changed; and an imaging pixel that is arranged adjacent to the event detection pixel and outputs a pixel signal corresponding to the light amount of the incident light on the basis of the photocurrent. Both the event detection pixel and the imaging pixel include a photoelectric conversion element that photoelectrically converts the incident light, a first pixel circuit that generates the detection signal, a second pixel circuit that generates the pixel signal, and a switching circuit that switches a circuit connected to the photoelectric conversion element to the first pixel circuit or the second pixel circuit.

Furthermore, the first pixel circuit, the second pixel circuit, and the switching circuit may each have a layout of circuit elements, the layout being substantially the same between the event detection pixel and the imaging pixel.

Furthermore, the switching circuit may include a switching transistor arranged between the photoelectric conversion element and the first pixel circuit, and a transfer transistor arranged between the photoelectric conversion element and the second pixel circuit, and
the switching transistor and the transfer transistor each have a layout of gate wires and gate electrodes, the layout being substantially the same between the event detection pixel and the imaging pixel.

Furthermore, in the event detection pixel, the switching transistor may have a gate connected with a first gate wire, the first gate wire being connected to a power supply line, and the transfer transistor may have a gate connected with a second gate wire, the second gate wire being connected to a negative potential wire, and
in the imaging pixel, the switching transistor may have a gate connected with a third gate wire, the third gate wire being connected to the negative potential wire, and the transfer transistor may have a gate connected with a fourth gate wire, the fourth gate wire being connected to a drive wire that transmits a pulse signal.

Furthermore, the first to fourth gate wires may extend in parallel to each other, and
the power supply line, the negative potential wire, and the drive wire may extend in a direction intersecting the first to fourth gate wires.

Furthermore, in the event detection pixel, the switching transistor may have a gate connected with a first gate wire, the first gate wire being connected to a first drive wire, and the transfer transistor may have a gate connected with a second gate wire, the second gate wire being connected to a second drive wire,
in the imaging pixel, the switching transistor may have a gate connected with a third gate wire, the third gate wire being connected to a third drive wire, and the transfer transistor may have a gate connected with a fourth gate wire, the fourth gate wire being connected to a fourth drive wire,
the first drive wire may receive input of a drive signal of a high level,
the second drive wire and the third drive wire may each receive input of a drive signal of a low level, and
the fourth drive wire may receive input of a pulse signal.

Furthermore, the first to fourth gate wires may extend in parallel to each other, and
the first to fourth drive wires may extend in a direction intersecting the first to fourth gate wires.

Furthermore, there may be provided a plurality of photoelectric conversion elements, a plurality of first pixel circuits, and a plurality of switching circuits for every one of a plurality of event detection pixels or a plurality of imaging pixels,
the second pixel circuit may be shared by the plurality of event detection pixels or the plurality of imaging pixels, and
each of the plurality of switching circuits may further include an addition transistor that adds the photocurrent.

Furthermore, the second pixel circuit may include: a floating diffusion region that accumulates electric charge of the photocurrent; a reset transistor that causes the electric charge to be released from the floating diffusion region; an amplifier transistor that generates the pixel signal on the basis of an electric charge amount of the electric charge; and a selection transistor that selects whether or not to output the pixel signal, and
the reset transistor, the amplifier transistor, and the selection transistor may be dispersedly arranged in the plurality of event detection pixels or the plurality of imaging pixels.

Furthermore, in one of the plurality of switching circuits provided in the plurality of event detection pixels, the switching transistor and the addition transistor may be in an on state and the transfer transistor may be in an off state, whereas in remaining ones of the switching circuits, the switching transistor and the addition transistor may be in an off state and the transfer transistor may be in an on state.

Furthermore, in the plurality of switching circuits provided in the plurality of imaging pixels, the switching transistor and the addition transistor may be in an off state, whereas the transfer transistor may be in an on state or an off state in accordance with a level of a pulse signal.

Furthermore, the second pixel circuit may be shared by event detection pixels whose number of pieces is larger than a number of pieces of imaging pixels sharing the second pixel circuit.

Furthermore, the plurality of imaging pixels may be arranged so as to surround a pixel block to be surrounded over the entire circumference, the pixel block having the plurality of event detection pixels being aligned in a matrix.

Furthermore, the event detection pixel may have a plurality of photoelectric conversion elements electrically connected by a diffusion layer containing n-type impurities.

Furthermore, the event detection pixel includes a wiring block in which a wire connected to the photoelectric conversion element is formed and a wiring block in which a wire connected to the circuit element is formed, the wiring blocks being separated by a distance, and the distance in the event detection pixel has a difference with the distance in the imaging pixel within a predetermined range.

Furthermore, the power supply line may have a T-shape in a portion overlapping the first gate wire and the third gate wire,
the negative potential wire may have an inverted T-shape in a portion overlapping the first gate wire and the third gate wire, and
the event detection pixel may include the power supply line and the negative potential wire forming a gap at a position, the position having a difference with a position of a gap between the power supply line and the negative potential wire in the imaging pixel within a predetermined range.

Furthermore, the power supply line and the negative potential wire in a peripheral region of the first gate wire may each have a pattern that is different from a pattern of the power supply line and the negative potential wire in a peripheral region of the third gate wire, and
the power supply line and the negative potential wire in the peripheral region of the first gate wire may be formed with a wiring density, the wiring density having a difference with a wiring density of the power supply line and the negative potential wire in the peripheral region of the third gate wire within an allowable range.

An electronic apparatus according to one aspect of the present disclosure includes a photodetection element including: an event detection pixel that outputs, on the basis of a photocurrent obtained by photoelectrically converting incident light, a detection signal indicating that a light amount of the incident light has changed, and an imaging pixel that is arranged adjacent to the event detection pixel and outputs a pixel signal corresponding to the light amount of the incident light on the basis of the photocurrent. Both the event detection pixel and the imaging pixel include a photoelectric conversion element that photoelectrically converts the incident light, a first pixel circuit that generates the detection signal, a second pixel circuit that generates the pixel signal, and a switching circuit that switches a circuit connected to the photoelectric conversion element to the first pixel circuit or the second pixel circuit.

### BRIEF DESCRIPTION OF DRAWINGS

FIG. 1 is a block diagram illustrating a configuration example of an electronic apparatus.

FIG. 2 is a diagram illustrating an example of a laminated structure of the photodetection element according to a first embodiment.

FIG. 3 is a diagram illustrating an example of a plan view of a light receiving chip according to the first embodiment.

FIG. 4 is a diagram illustrating an example of a plan view of a detection chip according to the first embodiment.

FIG. 5 is a circuit diagram illustrating a configuration of a pixel according to the first embodiment.

FIG. 6 is a diagram illustrating a layout of circuit elements of an event detection pixel and an imaging pixel according to the first embodiment.

FIG. 7 is a diagram illustrating a wiring layout of the event detection pixel and the imaging pixel according to the first embodiment.

FIG. 8 is a circuit diagram illustrating a configuration of a pixel according to a second embodiment.

FIG. 9 is a diagram illustrating a wiring layout of an event detection pixel and an imaging pixel according to the second embodiment.

FIG. 10 is a block diagram illustrating a configuration of a pixel block according to a third embodiment.

FIG. 11 is a diagram illustrating a layout of circuit elements of an event detection pixel and an imaging pixel according to the third embodiment.

FIG. 12 is a diagram illustrating an example of a layout of photoelectric conversion elements according to a modified example of the third embodiment.

FIG. 13 is a diagram illustrating a layout of circuit elements of an event detection pixel and an imaging pixel according to a fourth embodiment.

FIG. 14 is a cross-sectional view taken along a line X-X in FIG. 13.

FIG. 15 is a diagram illustrating a layout of a wiring block of the pixel according to Modification 1.

FIG. 16 is a diagram illustrating a wiring layout of the event detection pixel and the imaging pixel according to Modification 2.

FIG. 17 is a diagram illustrating a wiring layout of the event detection pixel and the imaging pixel according to Modification 3.

FIG. 18 is a block diagram illustrating a schematic configuration example of a vehicle control system.

FIG. 19 is an explanatory diagram illustrating an example of an installation position of an imaging section.

### MODE FOR CARRYING OUT THE INVENTION

Hereinafter, embodiments of a photodetection element will be described with reference to the drawings. In the following, main configuration parts of the photodetection element will be described, but the photodetection element may have configuration parts and functions that are not illustrated or described. The following description is not intended to exclude configuration parts and functions that are not illustrated or described.

The drawings are schematic or conceptual, and the ratio of each part and the like are not necessarily the same as actual ones. In the description and the drawings, similar elements to already described elements concerning the previously described drawings are denoted by the same reference signs, and detailed descriptions thereof are appropriately omitted.

### First Embodiment

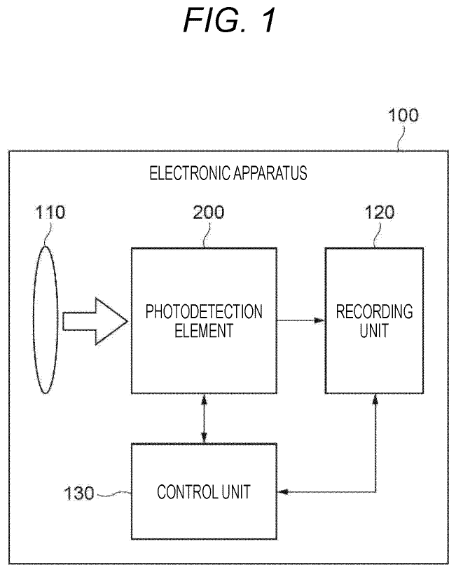

FIG. 1 is a block diagram illustrating a configuration example of an electronic apparatus 100 according to the present disclosure. The electronic apparatus 100 includes an optical unit 110, a photodetection element 200, a recording unit 120, and a control unit 130. The electronic apparatus 100 can be applied to, for example, a camera mounted on an industrial robot, a vehicle-mounted camera, a camera of an information processing terminal such as a smartphone, and the like.

The optical unit 110 condenses incident light and guides the light to the photodetection element 200. The photodetection element 200 photoelectrically converts the incident light to generate a detection signal and a pixel signal. Furthermore, the photodetection element 200 performs predetermined signal processing such as image recognition processing on the generated pixel signal, and outputs processed image data to the recording unit 120.

The recording unit 120 includes, for example, a flash memory or the like, and records image data output from the photodetection element 200 and data output from the control unit 130.

The control unit 130 includes, for example, an information processing device such as an application processor, and controls the photodetection element 200 to output image data and the like.

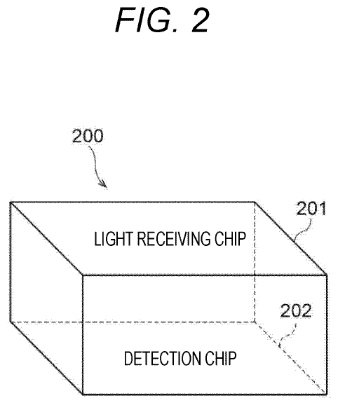

FIG. 2 is a diagram illustrating an example of a laminated structure of the photodetection element 200 according to a first embodiment. The photodetection element 200 includes a light receiving chip 201 and a detection chip 202 laminated on the light receiving chip 201. These chips are electrically connected to each other via a connection unit such as a contact via. Note that these chips can be connected by Cu—Cu bonding or a bump instead of a via.

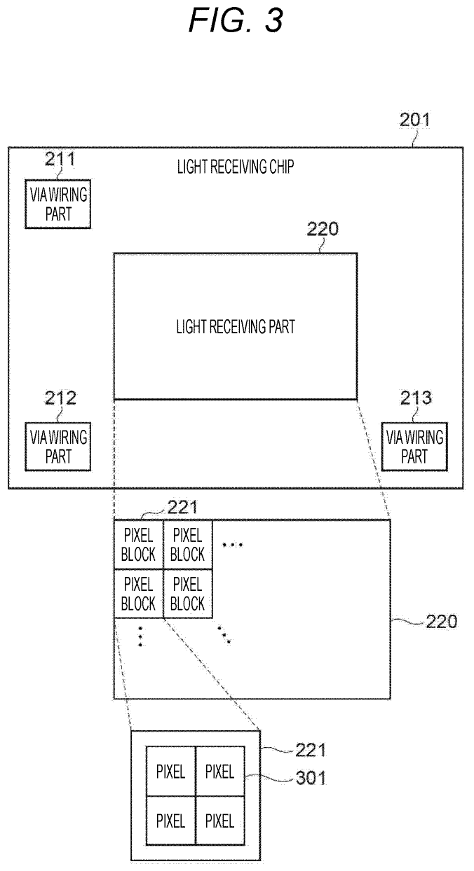

FIG. 3 is a diagram illustrating an example of a plan view of the light receiving chip 201 according to the first embodiment. The light receiving chip 201 is provided with a light receiving part 220 and via arrangement parts 211, 212, and 213.

Contact vias connected to the detection chip 202 are arranged in the via arrangement parts 211, 212, and 213. Furthermore, in the light receiving part 220, a plurality of pixel blocks 221 is aligned in a two-dimensional lattice manner.

One or two or more pixels 301 are aligned in each pixel block 221. For example, for every pixel block 221, four pixels 301 are aligned in 2 rows×2 columns. These four pixels 301 share a circuit on the detection chip 202. Note that the number of pixels 301 in the pixel block 221 is not limited to four. Furthermore, a part or all of the circuit configuration excluding a photoelectric conversion element 310 in each pixel 301 may be arranged on the detection chip 202. Each of the pixels 301 is assigned with a pixel address including a row address and a column address.

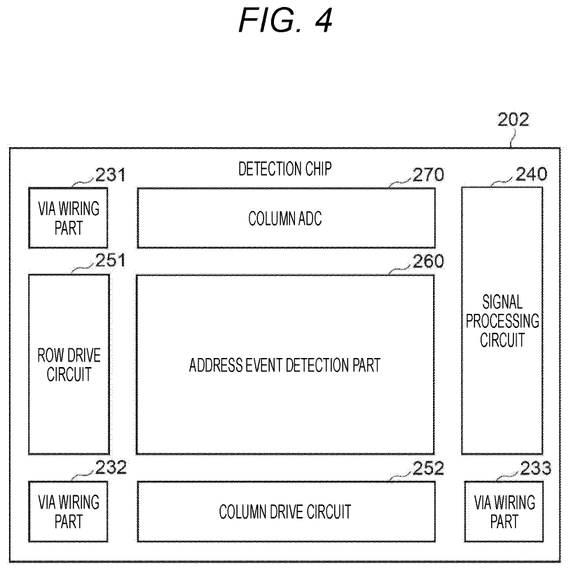

FIG. 4 is a diagram illustrating an example of a plan view of the detection chip 202 according to the first embodiment. On this detection chip 202, via arrangement parts 231, 232, and 233, a signal processing circuit 240, a row drive circuit 251, a column drive circuit 252, an address event detection part 260, and a column analog to digital converter (ADC) 270 are arranged. Contact vias connected to the light receiving chip 201 are arranged in the via arrangement parts 231, 232, and 233.

The address event detection part 260 detects the presence or absence of an address event for every pixel 301 and generates a detection signal indicating a detection result.

The row drive circuit 251 selects a row address and causes the address event detection part 260 to output a detection signal corresponding to the row address.

The column drive circuit 252 selects a column address and causes the address event detection part 260 to output a detection signal corresponding to the column address.

The signal processing circuit 240 executes predetermined signal processing on the detection signal from the address event detection part 260. The signal processing circuit 240 aligns the detection signals as pixel signals in a two-dimensional lattice manner, and acquires the image data having 2-bit information for every pixel. Then, the signal processing circuit 240 executes signal processing such as image recognition processing on the image data.

The column ADC 270 includes, for example, an analog to digital (AD) converter individually corresponding to each of vertical signal lines VSL provided for every pixel 301, and performs AD conversion on an analog pixel signal input from each response circuit 370 via the vertical signal line VSL. Furthermore, the column ADC 270 outputs the digital pixel signal after AD conversion to the signal processing circuit 240. The signal processing circuit 240 performs predetermined image processing on image data including digital pixel signals. Note that the column ADC 270 may include, for example, a correlated double sampling (CDS) circuit to reduce kTC noise included in the digital pixel signal.

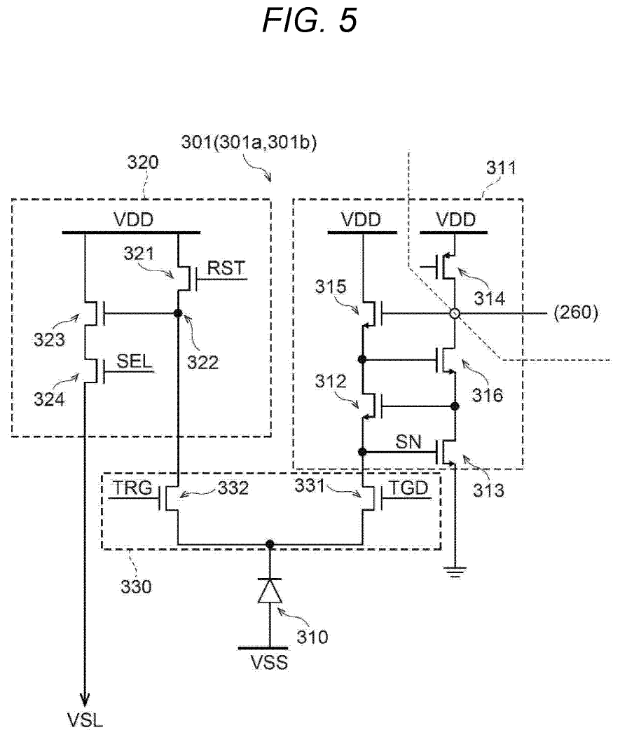

FIG. 5 is a circuit diagram illustrating a configuration of a pixel 301 according to the first embodiment. A pixel 301 illustrated in FIG. 5 includes the photoelectric conversion element 310, a first pixel circuit 311, a second pixel circuit 320, and a switching circuit 330. In the present embodiment, by the switching circuit 330 switching a connection circuit with the photoelectric conversion element 310 to the first pixel circuit 311 or the second pixel circuit 320, the pixel 301 functions as either an event detection pixel 301a or an imaging pixel 301b. Hereinafter, a configuration of the pixel 301 will be described.

The photoelectric conversion element 310 includes, for example, a photodiode that photoelectrically converts incident light to generate a photocurrent. The anode of the photoelectric conversion element 310 is connected to a negative potential wire VSS. The cathode of the photoelectric conversion element 310 is connected with the switching circuit 330. When the switching circuit 330 connects the photoelectric conversion element 310 to the first pixel circuit 311, the pixel 301 functions as the event detection pixel 301a. On the other hand, when the switching circuit 330 connects the photoelectric conversion element 310 to the second pixel circuit 320, the pixel 301 functions as the imaging pixel 301b.

The first pixel circuit 311 includes metal oxide semiconductor (MOS) transistors 312 and 313, a current source transistor 314, and MOS transistors 315 and 316. Each of the MOS transistors includes an n-channel MOS transistor.

In the first pixel circuit 311, a wire connected to the gate of the MOS transistor 313 and a wire through which the photocurrent flows from the photoelectric conversion element 310 via the switching circuit 330 function as a sense node SN at the time of detecting the address event. The source of the MOS transistor 312 is connected to the cathode of the photoelectric conversion element 310 via the switching circuit 330. The drain of the MOS transistor 312 is connected to a power supply line VDD via the MOS transistor 315.

The current source transistor 314 includes, for example, a p-channel MOS transistor. The current source transistor 314 supplies a constant current into the first pixel circuit 311. In the present embodiment, the current source transistor 314 is arranged on the detection chip 202. A connection point between the current source transistor 314 and the MOS transistor 316 functions as an output node together with the gate of the MOS transistor 315. The output node is connected to the input terminal of the address event detection part 260, and outputs, to the address event detection part 260, a detection signal indicating that the light amount of the incident light detected by the photoelectric conversion element 310 has changed.

The MOS transistor 315 is connected in series between the MOS transistor 312 and the power supply line VDD. The MOS transistor 316 is connected in series between the MOS transistor 313 and the current source transistor 314. The four MOS transistors 312, 313, 315, and 316 constitute, for example, a logarithmic conversion circuit that converts a value of the photocurrent output from the photoelectric conversion element 310 into a detection signal corresponding to the logarithmic value.

The second pixel circuit 320 shares the photoelectric conversion element 310 with the first pixel circuit 311 arranged in the same pixel 301, and generates a pixel signal corresponding to the received light amount of the photoelectric conversion element 310. As illustrated in FIG. 5, the second pixel circuit 320 includes a reset transistor 321, an amplifier transistor 323, and a selection transistor 324. Each of the pixel transistors includes, for example, an n-channel MOS transistor.

A node to which the source of the reset transistor 321 and the gate of the amplifier transistor 323 are connected functions as a floating diffusion region (FD) 322 having a current-voltage conversion function of converting electric charge accumulated in the photoelectric conversion element 310 into a voltage corresponding to the amount of the electric charge.

The drain of the reset transistor 321 and the drain of the amplifier transistor 323 are connected to, for example, the power supply line VDD. However, the drain of the reset transistor 321 may be connected to, for example, a reset voltage different from the power supply line VDD. The source of the amplifier transistor 323 is connected to the drain of the selection transistor 324, and the source of the selection transistor 324 is connected to the vertical signal line VSL. The vertical signal line VSL is connected to the column ADC 270. With this arrangement, an analog pixel signal is converted into a digital pixel signal by the column ADC 270.

When the second pixel circuit 320 is electrically connected to the photoelectric conversion element 310, the electric charge accumulated in the cathode of the photoelectric conversion element 310 is transferred to the floating diffusion region 322 via the switching circuit 330. As a result, a pixel signal having a voltage value corresponding to the amount of electric charge of the electric charge accumulated in the floating diffusion region 322 appears at the source of the amplifier transistor 323. When the row drive circuit 251 inputs a selection signal SEL of a high level to the gate of the selection transistor 324, the analog pixel signal that has appeared at the source of the amplifier transistor 323 appears in the vertical signal line VSL. When the row drive circuit 251 inputs a selection signal SEL of a low level to the gate of the selection transistor 324, the analog pixel signal does not appear in the vertical signal line VSL. In this manner, the selection transistor 324 selects whether or not to output the analog pixel signal to the vertical signal line VSL.

Furthermore, at the time of releasing the electric charge accumulated in the floating diffusion region 322 and resetting the floating diffusion region 322, the row drive circuit 251 inputs a reset signal RST of a high level to the gate of the reset transistor 321. With this arrangement, the electric charge accumulated in the floating diffusion region 322 is discharged to the power supply side via the reset transistor 321 (FD reset). At that time, the electric charge accumulated in the cathode of the photoelectric conversion element 310 can also be released to the power supply side (PD reset).

The switching circuit 330 includes a switching transistor 331 and a transfer transistor 332. The switching transistor 331 includes, for example, an n-channel MOS transistor, and is connected in series between the cathode of the photoelectric conversion element 310 and the MOS transistor 312. In a case where the pixel 301 functions as the event detection pixel 301a, the gate potential of the switching transistor 331 is constantly at a high level. Therefore, the switching transistor 331 is constantly in the on state. On the other hand, in a case where the pixel 301 functions as the imaging pixel 301b, the gate potential of the switching transistor 331 is constantly at a low level. Therefore, the switching transistor 331 is constantly in the off state.

The transfer transistor 332 includes, for example, an n-channel MOS transistor, and is connected in series between the cathode of the photoelectric conversion element 310 and the reset transistor 321. In a case where the pixel 301 functions as the event detection pixel 301a, for example, a transfer signal TRG of a low level is constantly applied to the gate of the transfer transistor 332. With this arrangement the transfer transistor 332 is constantly in the off state. As a result, the photocurrent output from the photoelectric conversion element 310 flows to the sense node SN side via the switching transistor 331 of the first pixel circuit 311.

On the other hand, in a case where the pixel 301 functions as the imaging pixel 301b, a transfer signal TRG that becomes a high level in accordance with a predetermined control operation is applied from the row drive circuit 251 to the gate of the transfer transistor 332. With this arrangement the transfer transistor 332 turns to the on state. During the period in which the transfer transistor 332 is in the on state, the electric charge accumulated in the photoelectric conversion element 310 is transferred to the floating diffusion region 322 of the second pixel circuit 320.

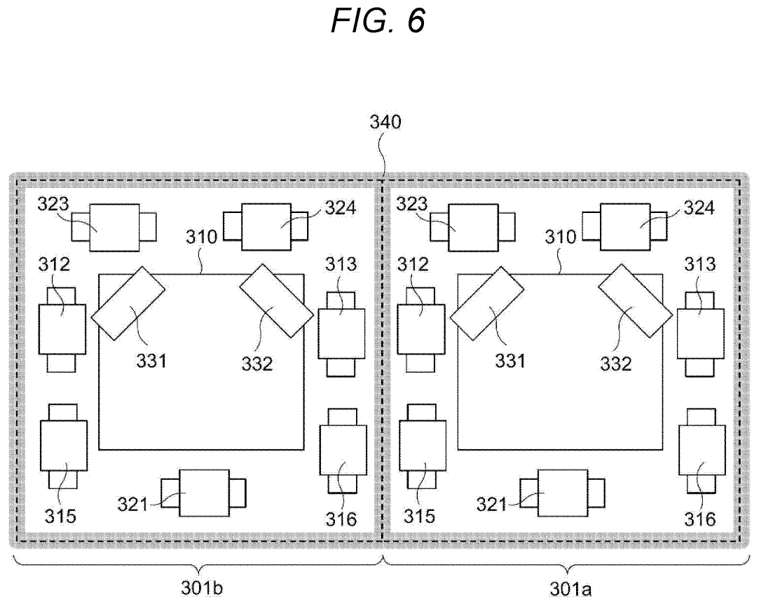

FIG. 6 is a diagram illustrating a layout of circuit elements of the event detection pixel 301a and the imaging pixel 301b according to the first embodiment. The circuit elements of the event detection pixel 301a and the imaging pixel 301b are arranged around the photoelectric conversion element 310. Furthermore, a front full trench isolation (FFTI) 340 that is an insulating film is formed on the outer peripheral portions of the event detection pixel 301a and the imaging pixel 301b.

As illustrated in FIG. 6, in a case where the event detection pixel 301a is arranged adjacent to the imaging pixel 301b, the layouts of the circuit elements of these pixels are substantially the same.

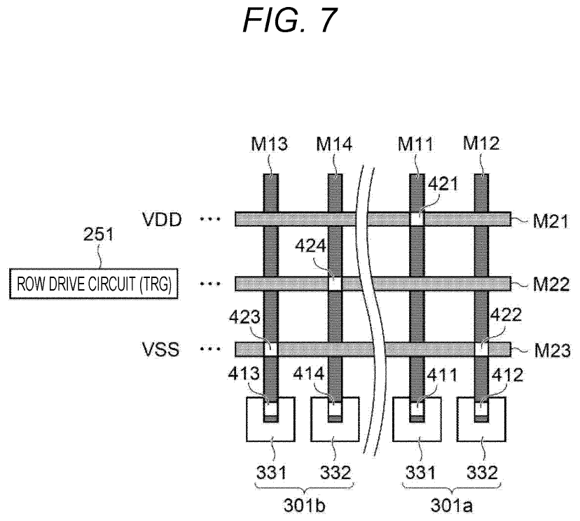

FIG. 7 is a diagram illustrating a wiring layout of the event detection pixel 301a and the imaging pixel 301b. FIG. 7 illustrates a layout of gate wires of each of the switching transistor 331 and the transfer transistor 332.

In the event detection pixel 301a, the gate of the switching transistor 331 is connected to a first gate wire M11 via a contact via 411. Meanwhile, the gate of the transfer transistor 332 is connected to a second gate wire M12 via a contact via 412. The second gate wire M12 extends in parallel with the first gate wire M11 in the same wiring layer as the first gate wire M11.

In the imaging pixel 301b, the gate of the switching transistor 331 is connected to a third gate wire M13 via a contact via 413. Meanwhile, the gate of the transfer transistor 332 is connected to a fourth gate wire M14 via a contact via 414. Similarly to the second gate wire M12, the third gate wire M13 and the fourth gate wire M14 also extend in parallel with the first gate wire M11 in the same wiring layer as the first gate wire M11.

The first gate wire M11 is connected to a wire M21 via a contact via 421. The wire M21 is the power supply line VDD formed in a wiring layer different from the first gate wire M11. The wire M21 extends in a direction intersecting with (a direction orthogonal in FIG. 7 to) the first gate wire M11.

The second gate wire M12 is connected to a wire M23 via a contact via 422. The wire M23 is the negative potential wire VSS formed in a wiring layer different from the second gate wire M12. The wire M23 extends in a direction intersecting with (a direction orthogonal in FIG. 7 to) the second gate wire M12.

By the event detection pixel 301a having the connection configuration of the wires as described above, the gate potential of the switching transistor 331 is constantly at the power supply voltage, that is, a high level. Therefore, this switching transistor 331 is constantly in the on state. Furthermore, the gate potential of the transfer transistor 332 is constantly at the negative potential voltage, that is, a low level. Therefore, this transfer transistor 332 is constantly in the off state. As a result, the photocurrent photoelectrically converted by the photoelectric conversion element 310 flows into the first pixel circuit 311. Therefore, the event detection pixel 301a can detect a change in the incident light amount.

In the imaging pixel 301b, the third gate wire M13 is connected to the wire M23 via a contact via 423. The fourth gate wire M14 is connected to a wire M22 via a contact via 424. The wire M22 is formed in a wiring layer different from the fourth gate wire M14, and is a drive wire that transmits the transfer signal TRG among a plurality of drive wires connected to the row drive circuit 251.

By the imaging pixel 301b having the connection configuration of the wires as described above, the gate potential of the switching transistor 331 is constantly at the negative potential voltage, that is, a low level. Therefore, this switching transistor 331 is constantly in the off state. Furthermore, the transfer signal TRG, which is a pulse signal in which a high level and a low level are alternately switched at a predetermined cycle, is input to the gate of the transfer transistor 332. Therefore, this transfer transistor 332 is turned to the off state or the on state in accordance with the level of the transfer signal TRG. As a result, the photocurrent photoelectrically converted by the photoelectric conversion element 310 flows into the second pixel circuit 320. Therefore, the imaging pixel 301b can generate a pixel signal corresponding to the incident light amount.

According to the present embodiment described above, both the event detection pixel 301a and the imaging pixel 301b include the first pixel circuit 311, the second pixel circuit 320, and the switching circuit 330. Therefore, in any of the case where the event detection pixels 301a are adjacent to each other, the case where the imaging pixels 301b are adjacent to each other, and the case where the event detection pixel 301a and the imaging pixel 301b are adjacent to each other, the photodetection element 200 is configured by repeating units having substantially the same pixel structure. Therefore, the uniformity of the characteristics of the event detection pixel 301a and the imaging pixel 301b is improved.

Furthermore, according to the present embodiment, between the event detection pixel 301a and the imaging pixel 301b, the layouts of the circuit elements of the first pixel circuit 311, the second pixel circuit 320, and the switching circuit 330 are substantially the same, and the layouts of the gate wires of the switching transistor 331 and the transfer transistor 332 are also substantially the same. Therefore, uniformity of pixel characteristics can be improved. Note that, in the present embodiment, in order to further improve the uniformity of the pixel characteristics, it is desirable that the layout of not only the gate wires but also the gate electrodes be substantially the same between the switching transistor 331 and the transfer transistor 332.

### Second Embodiment

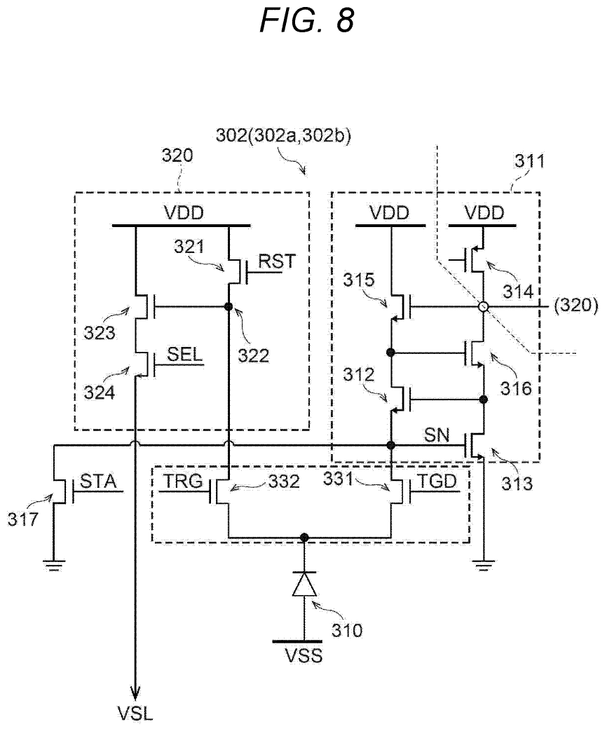

FIG. 8 is a circuit diagram illustrating a configuration of a pixel 302 according to a second embodiment. Components similar to the pixel 301 according to the first embodiment are denoted by the same reference signs, and detailed description thereof will be omitted. Hereinafter, points different from the pixel 301 according to the first embodiment will be mainly described.

The pixel 302 according to the present embodiment further includes a control transistor 317 in addition to the circuit elements of the pixel 301 according to the first embodiment. In FIG. 8, the control transistor 317 is arranged outside a first pixel circuit 311, but may be arranged in the first pixel circuit 311.

The control transistor 317 includes, for example, an n-channel MOS transistor. The drain of the control transistor 317 is respectively connected to the source of a MOS transistor 312, the gate of a MOS transistor 313, and the drain of a switching transistor 331. The source of the control transistor 317 is grounded. For example, a control signal STA for controlling on and off of the control transistor 317 is applied from a row drive circuit 251 to the gate of the control transistor 317.

In the present embodiment, one pixel 302 can be switched between an EVS mode of operating as an event detection pixel 301a and a CIS mode of operating as an imaging pixel 302b. In a case where the pixel 302 operates as the event detection pixel 301a, the control signal STA of a high level is applied to the gate of the control transistor 317. With this arrangement, the control transistor 317 is turned to the on state, and the SN potential of a sense node SN is controlled to the ground potential. Therefore, even if the switching transistor 331 is transitioned to the on state, an unintended increase in the SN potential can be suppressed. As a result, the MOS transistor 312 and a MOS transistor 315 can be avoided from being turned to the off state, and thus, a dead period can be suppressed, the period occurring due to the voltage level of the detection signal sticking to the ground potential (GND).

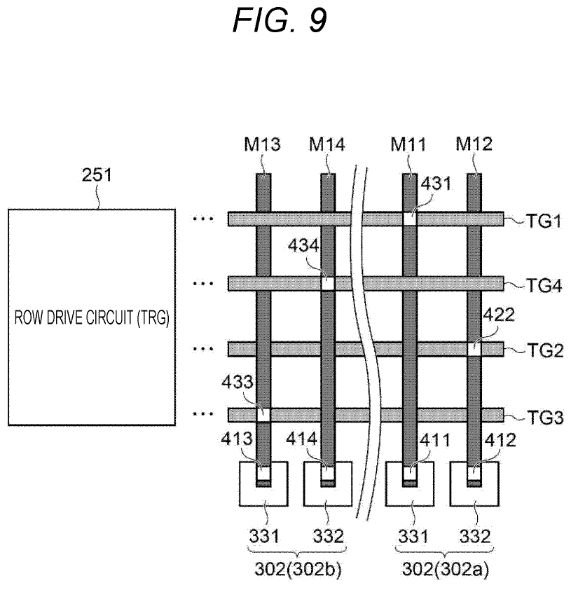

In the present embodiment, because the layouts of the circuit elements of the first pixel circuit 311 and a second pixel circuit 320 are similar to those of the first embodiment, the description thereof will be omitted. On the other hand, the gate wire layout of the switching transistor 331 and a transfer transistor 332 is different from that of the first embodiment, and thus, will be described with reference to FIG. 9.

FIG. 9 is a diagram illustrating a wiring layout of the event detection pixel 302a and the imaging pixel 302b according to the second embodiment. FIG. 9 illustrates the layout of gate wires each of the switching transistor 331 and the transfer transistor 332.

In each of the event detection pixel 302a and the imaging pixel 302b, the connection form between the gates of the switching transistor 331 and the transfer transistor 332 and a first gate wire M11 to a fourth gate wire M14 is the same as that in the first embodiment, and thus, the description thereof is omitted.

In the present embodiment, the first gate wire M11 is connected to a first drive wire TG1 via a contact via 431. The second gate wire M12 is connected to a second drive wire TG2 via a contact via 432. The third gate wire M13 is connected to a third drive wire TG3 via a contact via 433. The fourth gate wire M14 is connected to a fourth drive wire TG4 via a contact via 434. The first drive wire TG1 to the fourth drive wire TG4 are formed in a wiring layer different from the first gate wire M11 to the fourth gate wire M14, and are connected to a row drive circuit 251. Furthermore, the drive wires are parallel to each other and extend in a direction intersecting the gate wires.

First, in a case where the pixel 302 arranged on the right side in FIG. 9 operates as the event detection pixel 302a and the pixel 302 arranged on the left side in FIG. 9 operates as the imaging pixel 302b, a drive signal transmitted in each drive wire will be described. In this case, the row drive circuit 251 outputs a drive signal of a high level to the first drive wire TG1, and meanwhile, outputs a drive signal of a low level to the second drive wire TG2.

The drive signal of a high level described above is input to the gate of the switching transistor 331 via the first gate wire M11. With this arrangement, this switching transistor 331 is turned to the on state. Meanwhile, the drive signal of a low level described above is input to the gate of the transfer transistor 332 via the second gate wire M12. With this arrangement, this transfer transistor 332 is turned to the off state. As a result, the pixel 302 on the right side can detect, as the event detection pixel 302a, a change in light amount of the incident light.

Furthermore, the row drive circuit 251 outputs a drive signal of a low level to the third drive wire TG3, and meanwhile, outputs a transfer signal TRG to the fourth drive wire TG4. This drive signal of a low level is input to the gate of the switching transistor 331 via the third gate wire M13. With this arrangement, this switching transistor 331 is turned to the off state. Meanwhile, the transfer signal TRG is input to the gate of the transfer transistor 332 via the fourth gate wire M14. With this arrangement this transfer transistor 332 is turned to the off state or the on state in accordance with the level of the transfer signal TRG. As a result, the pixel 302 on the left side can generate, as the imaging pixel 302b, a pixel signal corresponding to the light amount of the incident light.

Next, in a case where the pixel 302 arranged on the right side in FIG. 9 operates as the imaging pixel 302b and the pixel 302 arranged on the left side in FIG. 9 operates as the event detection pixel 301a, a drive signal transmitted in each drive wire will be described. In this case, the row drive circuit 251 outputs a drive signal of a low level to the first drive wire TG1, and meanwhile, outputs a transfer signal TRG to the second drive wire TG2.

The drive signal of a low level described above is input to the gate of the switching transistor 331 via the first gate wire M11. With this arrangement, this switching transistor 331 is turned to the off state. Meanwhile, the transfer signal TRG described above is input to the gate of the transfer transistor 332 via the second gate wire M12. With this arrangement this transfer transistor 332 is turned to the off state or the on state in accordance with the level of the transfer signal TRG. As a result, the pixel 302 on the right side operates as the imaging pixel 302b.

Furthermore, the row drive circuit 251 outputs a drive signal of a high level to the third drive wire TG3, and meanwhile, outputs a drive signal of a low level to the fourth drive wire TG4. This drive signal of a high level is input to the gate of the switching transistor 331 via the third gate wire M13. With this arrangement, this switching transistor 331 is turned to the on state. Meanwhile, this drive signal of a low level is input to the gate of the transfer transistor 332 via the fourth gate wire M14. With this arrangement, this transfer transistor 332 is turned to the off state. As a result, the pixel 302 on the left side operates as the event detection pixel 302a.

Also according to the present embodiment described above, similarly to the first embodiment, both the event detection pixel 302a and the imaging pixel 302b include the first pixel circuit 311, the second pixel circuit 320, and the switching circuit 330. Therefore, regardless of the type of the adjacent pixel, the photodetection element 200 is configured by repeating units having substantially the same pixel structure. Therefore, the uniformity of the characteristics of the event detection pixel 302a and the imaging pixel 302b is improved.

In addition, in the present embodiment, by switching the signals to be output to the first drive wire TG1 to the fourth drive wire TG4, the row drive circuit 251 can freely switch the operation mode of the pixel 302 between the EVS mode in which the pixel operates as the event detection pixel 302a and the CIS mode in which the pixel operates as the imaging pixel 302b Note that, also in the present embodiment, in order to further improve the uniformity of the pixel characteristics, it is desirable that the layout of not only the gate wires but also the gate electrodes be substantially the same between the switching transistor 331 and the transfer transistor 332.

### Third Embodiment

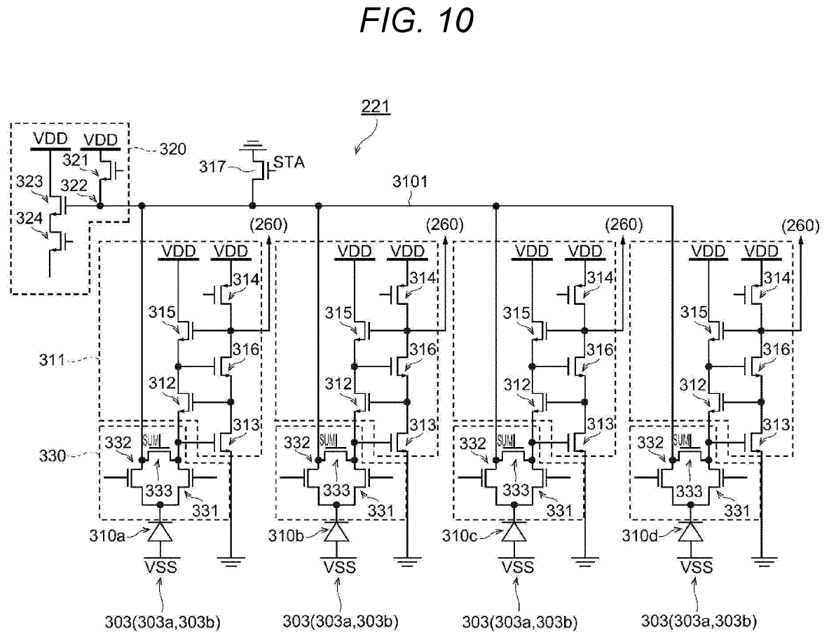

FIG. 10 is a block diagram illustrating a configuration of a pixel block 221 according to a third embodiment. Components similar to the pixel 301 according to the first embodiment and the pixel 302 according to the second embodiment are denoted by the same reference signs here, and detailed description thereof will be omitted. Hereinafter, points different from the pixel 301 according to the first embodiment and the pixel 302 according to the second embodiment will be mainly described.

The pixel block 221 according to the present embodiment includes four pixels 303. The four pixels 303 belonging to the same pixel block 221 individually include any of photoelectric conversion elements 310a to 310d, a first pixel circuit 311, and a switching circuit 330. On the other hand, the four pixels 303 share a second pixel circuit 320 and a control transistor 317 via a common wire 3101.

Furthermore, a switching circuit 330 according to the present embodiment further includes an addition transistor 333 in addition to a switching transistor 331 and a transfer transistor 332. The addition transistor 333 includes, for example, an n-channel MOS transistor. The source of the addition transistor 333 is connected to the drain of the transfer transistor 332. The drain of the addition transistor 333 is connected to, for example, the drain of the switching transistor 331, the source of a MOS transistor 312, and the gate of a MOS transistor 313. A drive signal SUM is input from a row drive circuit 251 to the gate of the addition transistor 333. The addition transistor 333 is switched between the on state and the off state in accordance with the level of the drive signal SUM.

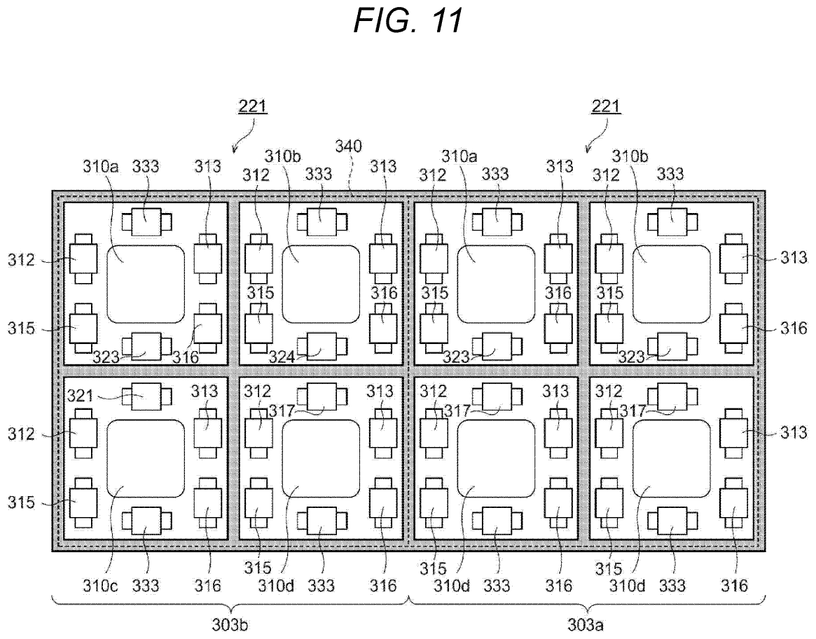

FIG. 11 is a diagram illustrating a layout of circuit elements of an event detection pixel 303a and an imaging pixel 303b according to the third embodiment. Note that, although the switching transistor 331 and the transfer transistor 332 are not illustrated in FIG. 11, these transistors are arranged on the photoelectric conversion element 310 similarly to the first embodiment (see FIG. 6).

As illustrated in FIG. 11, the layout of the circuit elements is the same between the event detection pixel 303a and the imaging pixel 303b. Therefore, here, the layout of the circuit elements of the event detection pixel 303a will be described.

In the event detection pixel 303a according to the present embodiment, the second pixel circuit 320 and the control transistor 317 are shared in one pixel block 221. The second pixel circuit 320 includes a reset transistor 321, an amplifier transistor 323, and a selection transistor 324.

The reset transistor 321 is arranged in the event detection pixel 303a having the photoelectric conversion element 310c. The amplifier transistor 323 is arranged in the event detection pixel 303a having the photoelectric conversion element 310a and faces the reset transistor 321. The selection transistor 324 is arranged in the event detection pixel 303a having the photoelectric conversion element 310b. In this manner, the respective transistors of the second pixel circuit 320 are dispersedly arranged in the plurality of event detection pixels 303a. The control transistor 317 is arranged in the event detection pixel 303a having the photoelectric conversion element 310d and faces the control transistor 317.

Furthermore, in the present embodiment, the layout of the first embodiment or the second embodiment can be applied to the layout of the gate wires of each of the switching transistor 331 and the transfer transistor 332. Here, the operation of the pixel block 221 including the four event detection pixels 303a and the operation of the pixel block 221 including the four imaging pixels 303b will be described.

In the pixel block 221 having the four event detection pixels 303a, the row drive circuit 251 constantly turns on the switching transistor 331, constantly turns off the transfer transistor 332, and constantly turns on the addition transistor 333 in the event detection pixel 303a having the photoelectric conversion element 310a. At the same time, the row drive circuit 251 constantly turns off the switching transistor 331, constantly turns on the transfer transistor 332, and constantly turns off the addition transistor 333 in the remaining three event detection pixels 303a. Moreover, the row drive circuit 251 constantly turns off the control transistor 317.

In the case described above, in the event detection pixel 303a having the photoelectric conversion element 310a, the photocurrent photoelectrically converted by the photoelectric conversion element 310a flows into the first pixel circuit 311 via the switching transistor 331. At the same time, the photocurrents photoelectrically converted by the photoelectric conversion element 310b to the photoelectric conversion element 310d are collected in the event detection pixel 303a having the photoelectric conversion element 310a via the transfer transistor 332 and the common wire 3101. The collected photocurrent joins this first pixel circuit 311 via the addition transistor 333 of the event detection pixel 303a. Because the photocurrents of the photoelectric conversion element 310a to the photoelectric conversion element 310d are added in this manner, these four photoelectric conversion elements effectively function as one photoelectric conversion element.

As a result, the pixel block 221 having the four event detection pixels 303a is configured as 1×1 pixel. As described above, by adopting a configuration in which the photocurrents generated by the plurality of photoelectric conversion elements 310 can be aggregated into one first pixel circuit 311, a larger amount of photocurrent can be secured. Therefore, the dynamic range in the photocurrent detection can be expanded. As a result, a sufficiently wide dynamic range can be secured even at low illuminance or the like.

Meanwhile, in the pixel block 221 having the four imaging pixels 303b, the row drive circuit 251 constantly turns off the switching transistor 331 and the addition transistor 333 of each imaging pixel 303b, and inputs a transfer signal TRG to the transfer transistor 332. Moreover, the row drive circuit 251 constantly turns off the control transistor 317.

In the case described above, the photocurrents photoelectrically converted by the photoelectric conversion element 310a to the photoelectric conversion element 310d flow into the second pixel circuit 320 via the transfer transistor 332 and the common wire 3101. In a floating diffusion region 322 of the second pixel circuit 320, a pixel signal corresponding to the photocurrent amount of each photoelectric conversion element is generated. Because the pixel signal corresponding to each of the photocurrents of the photoelectric conversion element 310a to the photoelectric conversion element 310d is individually generated in this manner, the photoelectric conversion element 310a to the photoelectric conversion element 310d function as four independent photoelectric conversion elements. As a result, the pixel block 221 having the four imaging pixels 303b is configured as 2 rows×2 columns pixels.

According to the present embodiment described above, the effective area of the photoelectric conversion element in the event detection pixel 303a can be made larger than that of the imaging pixel 303b by adding the photocurrents of the photoelectric conversion elements by using the addition transistor 333. Furthermore, the layout of the circuit elements is the same between the event detection pixel 303a and the imaging pixel 303b. Therefore, a pixel structure in which the effective sizes of the photoelectric conversion elements are different can be adopted without sacrificing the uniformity of each of the pixel characteristics of the event detection pixel 303a and the imaging pixel 303b.

Note that, in the present embodiment, the photocurrents of the four photoelectric conversion elements are added in the event detection pixel 303a, but the number of photoelectric conversion elements to which the photocurrents are added is not particularly limited.

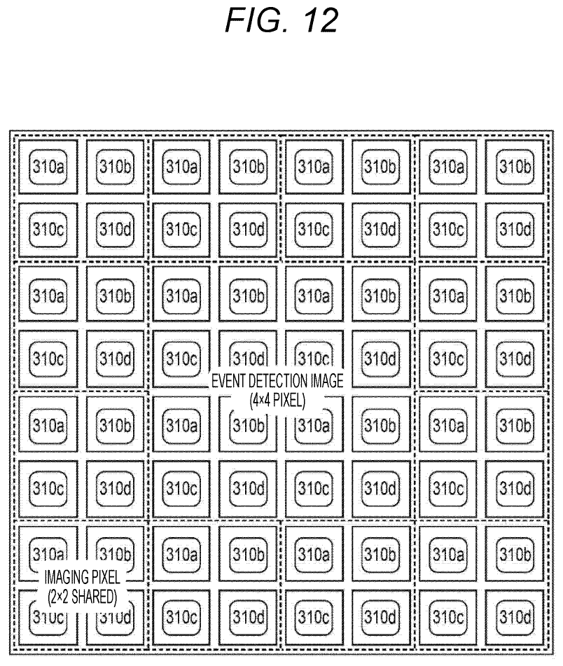

FIG. 12 is a diagram illustrating an example of the layout of the photoelectric conversion elements according to a modified example of the third embodiment. In the modified example illustrated in FIG. 12, one second pixel circuit 320 is shared by 16 event detection pixels 303a. That is, 16 photocurrents are added by one first pixel circuit 311. Therefore, the event detection pixel 303a according to the present modified example functions as 4 rows×4 columns pixels.

Furthermore, in the present modified example, the plurality of imaging pixels 301b is arranged so as to surround the pixel block including the 16 event detection pixels 303a arranged in a matrix of 4 rows×4 columns over the entire circumference.

Furthermore, one second pixel circuit 320 is shared by the four imaging pixels 301b. Furthermore, the second pixel circuit 320 generates a pixel signal for every photocurrent of each photoelectric conversion element. Therefore, the imaging pixel 303b according to the present modified example functions as 2 rows×2 columns pixels.

Even in the layout according to the present modified example, the layout of the circuit elements is the same between the event detection pixel 303a and the imaging pixel 303b. Therefore, a pixel structure in which the effective sizes of the photoelectric conversion elements are different can be adopted without sacrificing the uniformity of each of the pixel characteristics.

### Fourth Embodiment

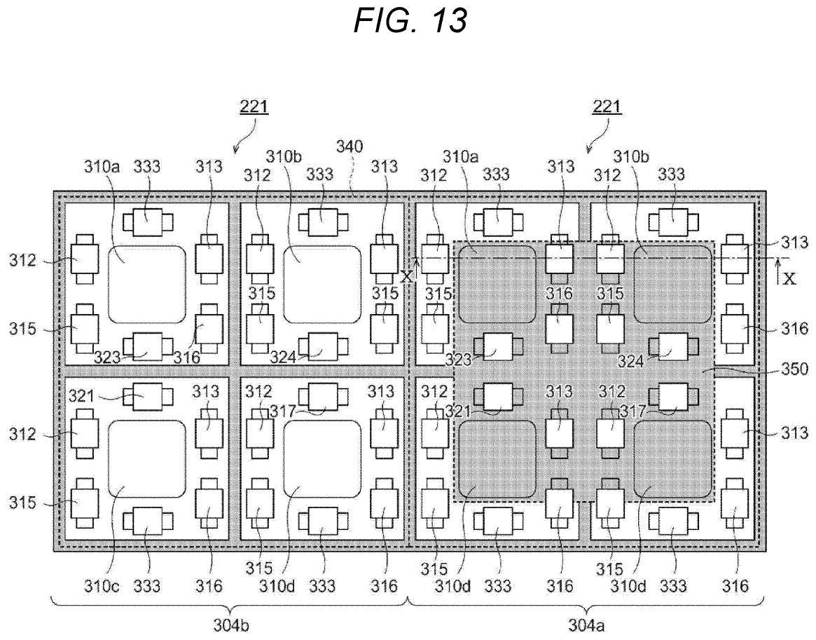

FIG. 13 is a diagram illustrating a layout of circuit elements of an event detection pixel 304a and an imaging pixel 304b according to a fourth embodiment. Note that, although a switching transistor 331 and a transfer transistor 332 are not illustrated in FIG. 13, each of the transistors are respectively arranged on photoelectric conversion elements 310a to 310d similarly to the first embodiment (see FIG. 6).

As illustrated in FIG. 13, also in the present embodiment, the layout of the circuit elements is the same between the event detection pixel 304a and the imaging pixel 304b. However, in the event detection pixel 304a according to the present embodiment, the four photoelectric conversion elements 310a to 310d belonging to the same pixel block 221 are electrically connected by a diffusion layer 350 containing n-type impurities.

Therefore, in the present embodiment, MOS transistors 312, 313, 315, and 316, the switching transistor 331, and the transfer transistor 332 of the event detection pixel 304a having the photoelectric conversion element 310a are active pixel transistors. On the other hand, the transistors provided in a first pixel circuit 311 and a switching circuit 330 of the event detection pixel 304a having the remaining three photoelectric conversion elements 310b to 310d are dummy pixel transistors. Moreover, transistors provided in a second pixel circuit 320 and a control transistor 317 are also dummy pixel transistors. The source and the drain of the dummy pixel transistors are connected to a power supply line VDD or are electrically floating.

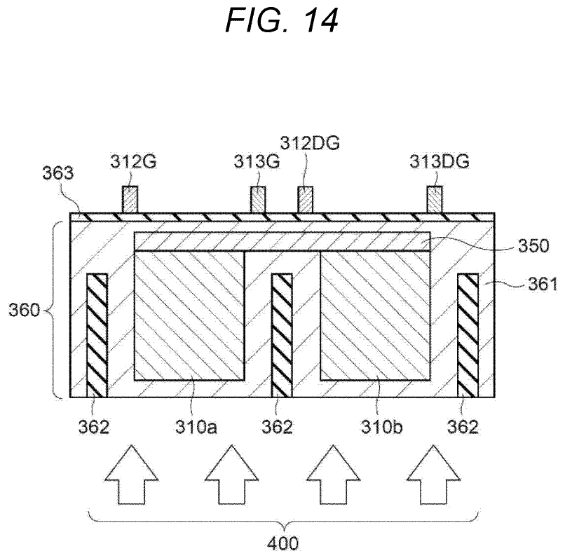

FIG. 14 is a cross-sectional view taken along a line X-X in FIG. 13. In FIG. 14, the photoelectric conversion element 310a and the photoelectric conversion element 310b are formed in a p-well region 361 of a semiconductor substrate 360. A reverse deep trench isolation (RDTI) 362, which is an insulating film, is formed between the photoelectric conversion element 310a and the photoelectric conversion element 310b. The RDTI 362 extends from the back surface of the semiconductor substrate 360 and terminates halfway through the p-well region 361.

Cathodes of the photoelectric conversion element 310a and the photoelectric conversion element 310b are connected to each other by a diffusion layer 350. Although not illustrated in FIG. 14, this diffusion layer 350 is connected with a cathode of each of the photoelectric conversion element 310c and the photoelectric conversion element 310d.

A gate oxide film 363 is formed on the surface of the semiconductor substrate 360. Gate electrodes of various pixel transistors provided in the first pixel circuit 311, the second pixel circuit 320, and the switching circuit 330 are formed on the gate oxide film 363. For example, FIG. 14 illustrates a gate electrode 312G of the MOS transistor 312 and a gate electrode 316G of the MOS transistor 316 of the event detection pixel 304a having the photoelectric conversion element 310a. The gate electrode 312G and the gate electrode 316G are gate electrodes of the active pixel transistor.

Furthermore, FIG. 14 illustrates a gate electrode 312DG of the MOS transistor 312 and a gate electrode 313DG of the MOS transistor 316 of the event detection pixel 304a having the photoelectric conversion element 310b. The gate electrode 312DG and the gate electrode 313DG are gate electrodes of the dummy pixel transistor.

In the event detection pixel 304a configured as described above, when light 400 is incident from the back surface of the semiconductor substrate 360, the photocurrent of each of the photoelectric conversion elements gathers via the diffusion layer 350. At this time, because the switching circuit 330 of the event detection pixel 304a having the photoelectric conversion element 310a is in the on state, the collected photocurrent flows into the first pixel circuit 311 of this event detection pixel 304a. The first pixel circuit 311 logarithmically converts the inflowing photocurrent to generate a detection signal.

Meanwhile, in the imaging pixel 304b, similarly to the third embodiment, a row drive circuit 251 constantly turns off the switching transistor 331 and an addition transistor 333, and inputs a transfer signal TRG to the transfer transistor 332. Moreover, the row drive circuit 251 constantly turns off the control transistor 317.

As a result, the photoelectric conversion element 310a to the photoelectric conversion element 310d photoelectrically convert the light 400 incident from the back surface of the semiconductor substrate 360 similarly to the event detection pixel 304a. The photocurrents generated by photoelectric conversion flows into the second pixel circuit 320 via the transfer transistor 332 and a common wire 3101. In a floating diffusion region 322 of the second pixel circuit 320, a pixel signal corresponding to the photocurrent amount of each photoelectric conversion element is generated. Because the pixel signal corresponding to each of the photocurrents of the photoelectric conversion element 310a to the photoelectric conversion element 310d is individually generated in this manner, the photoelectric conversion element 310a to the photoelectric conversion element 310d function as four independent photoelectric conversion elements. As a result, the pixel block 221 having the four imaging pixels 303b is configured as 2 rows×2 columns pixels.

According to the present embodiment described above, the effective area of the photoelectric conversion element in the event detection pixel 303a can be made larger than that of the imaging pixel 303b by collecting the photocurrents of the photoelectric conversion elements by using the diffusion layer 350 including the n-type impurities. Furthermore, the layout of the circuit elements is the same between the event detection pixel 303a and the imaging pixel 303b. Therefore, a pixel structure in which the effective sizes of the photoelectric conversion elements are different can be adopted without sacrificing the uniformity of each of the pixel characteristics of the event detection pixel 303a and the imaging pixel 303b.

### Modification 1

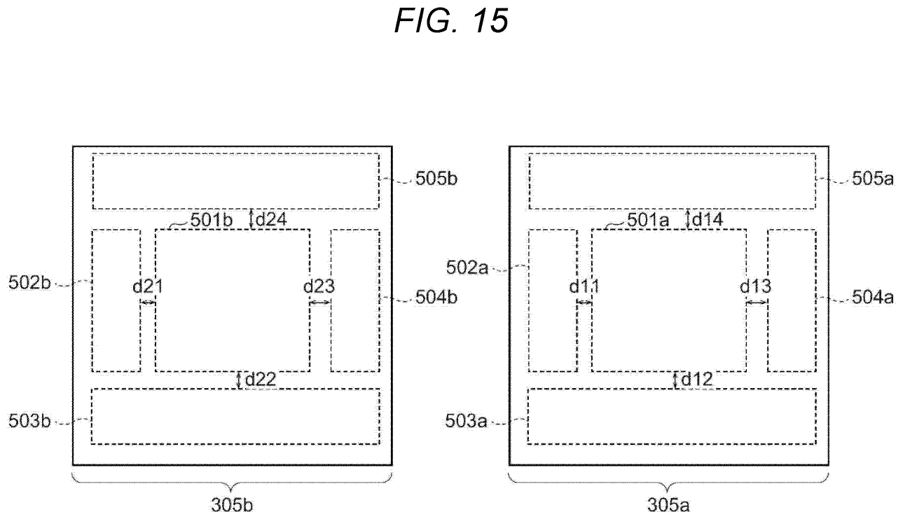

FIG. 15 is a diagram illustrating a layout of a wiring block of the pixel according to Modification 1. FIG. 15 is a diagram illustrating a layout of a wiring block of each of an event detection pixel 305a and an imaging pixel 301b according to Modification 1. The wiring block is a formation area of wires connected to a circuit element arranged in the wiring block.

The event detection pixel 305a according to the present modification includes a wiring block 501a to a wiring block 505a. Furthermore, the imaging pixel 305b according to the present modification includes a wiring block 501b to a wiring block 505b.

In the wiring blocks 501a and 501b, wires connected to the photoelectric conversion element 310 are formed. In the wiring blocks 502a and 502b, wires respectively connected to the MOS transistors 312 and 315 of the first pixel circuit 311 are formed.

In the wiring blocks 503a and 503b, wires connected to the reset transistor 321, the amplifier transistor 323, the selection transistor 324, or the addition transistor 333 are formed according to the first embodiment to the fourth embodiment described above.

In the wiring blocks 504a and 504b, wires respectively connected to the MOS transistors 313 and 316 of the first pixel circuit 311 are formed. In the wiring blocks 505a and 505b, wires connected to the amplifier transistor 323, the selection transistor 324, or the addition transistor 333 are formed according to the first embodiment to the fourth embodiment described above.

In the event detection pixel 305a, the remaining wiring blocks 502a to 505d are arranged around the wiring block 501a. Meanwhile, in the imaging pixel 305b, the remaining wiring blocks 502b to 505d are arranged around the wiring block 501b. In the present embodiment, the distance between the wiring block 501a arranged at the center and the remaining wiring blocks 502a to 505d is different between the event detection pixel 305a and the imaging pixel 305b.

Specifically, a distance d11 between the wiring block 501a and the wiring block 502a is larger than a distance d21 between the wiring block 501b and the wiring block 502b. Furthermore, a distance d12 between the wiring block 501a and the wiring block 503a is larger than a distance d22 between the wiring block 501b and the wiring block 503b. Furthermore, a distance d13 between the wiring block 501a and the wiring block 504a is larger than a distance d23 between the wiring block 501b and the wiring block 504b. Moreover, a distance d14 between the wiring block 501a and the wiring block 505a is larger than a distance d24 between the wiring block 501b and the wiring block 505b. That is, in the present modification, the event detection pixel 305a has an arrangement in which the wiring blocks 502a to 505a are shifted from the wiring block 501a (501b) further outward as a whole than the wiring blocks 502b to 505b of the imaging pixel 301b.

In the first embodiment described above, the layout of the circuit elements is the same between the event detection pixel and the imaging pixel. On the other hand, in the present modification, a case where the difference in distance between the wiring blocks 501a and 501b of the photoelectric conversion element 310 is within a predetermined range between the event detection pixel 305a and the imaging pixel 305b is illustrated as an example in which the layouts of the circuit elements are substantially the same.

### Modification 2

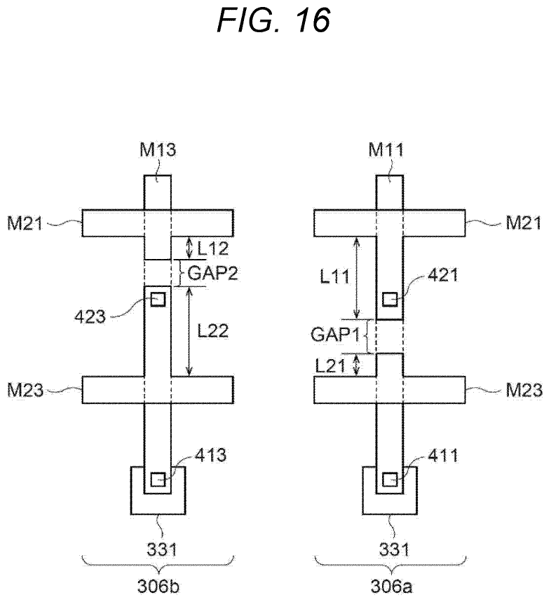

FIG. 16 is a diagram illustrating a wiring layout of an event detection pixel 306a and an imaging pixel 306b according to Modification 2. FIG. 16 illustrates a layout of the gate wires of the switching transistor 331 of each of the event detection pixel 306a and the imaging pixel 306b.

The wire M21 according to the present modification has a T-shape in a portion overlapping the first gate wire M11 and the third gate wire M13. A length L11 of the T-shape formed in the portion overlapping the first gate wire M11 is longer than a length L12 of the T-shape formed in the portion overlapping the third gate wire M13.

Furthermore, the wire M23 according to the present modification has an inverted T-shape in a portion overlapping the first gate wire M11 and the third gate wire M13. A length L21 of the inverted T-shape formed in the portion overlapping the first gate wire M11 is longer than a length L22 of the inverted T-shape formed in the portion overlapping the third gate wire M13. Therefore, the position of a gap GAP1 between the wire M21 and the wire M23 formed in the portion overlapping the first gate wire M11 is slightly different from the position of a gap GAP2 between the wire M21 and the wire M23 formed in the portion overlapping the third gate wire M13.

In the present disclosure, as in the present modification, even in a case where the difference in the positions of the gaps of the wire M21 and the wire M23 is within a predetermined range between the event detection pixel 306a and the imaging pixel 306b, similarly to the first embodiment, the case is also included in an example in which the layout of the gate wires of the switching transistor 331 is substantially the same.

### Modification 3

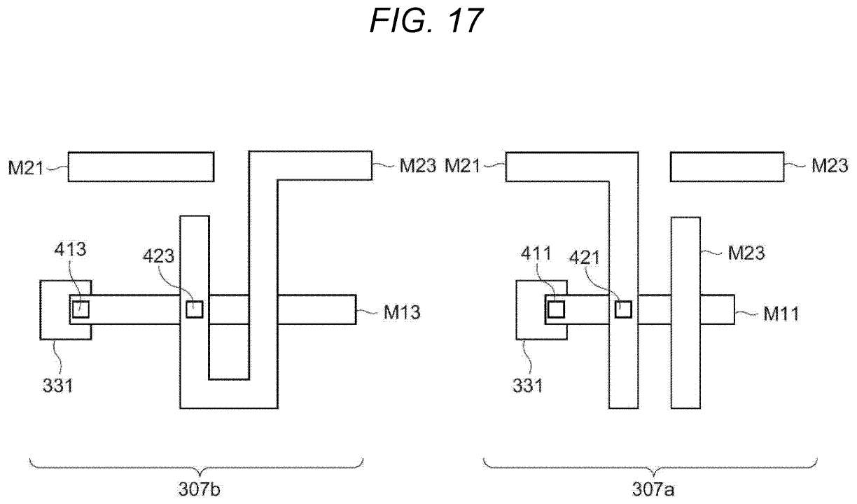

FIG. 17 is a diagram illustrating a wiring layout of an event detection pixel 307a and an imaging pixel 307b according to Modification 3. FIG. 17 illustrates a layout of the gate wires of the switching transistor 331 of each of the event detection pixel 307a and the imaging pixel 307b.

Comparing the event detection pixel 307a and the imaging pixel 307b, the patterns (routing) of the wires M21 and M23 in the peripheral region of the first gate wire M11 are slightly different from the patterns of the wires 21 and M23 in the peripheral region of the third gate wire M13. On the other hand, the wiring density indicating the ratio of the areas of the wires M21 and M23 to the area of the peripheral region of the first gate wire M11 is substantially the same as the wiring density indicating the ratio of the areas of the wires M21 and M23 to the area of the peripheral region of the third gate wire M13.

In the present disclosure, as in the present modification, even in a case where the patterns of the wire M21 and the wire M23 in the peripheral region of the third gate wire M13 are different between the event detection pixel 307a and the imaging pixel 307b, similarly to the first embodiment, in a case where the difference in density of the wire M21 and the wire M23 is within an allowable range, the case is also included in an example in which the layout of the gate wires of the switching transistor 331 is substantially the same.

### Application Example to Mobile Body

The technology according to the present disclosure (the present technology) can be applied to various products. For example, the technology according to the present disclosure may be implemented as a device included in any type of mobile body such as an automobile, an electric vehicle, a hybrid electric vehicle, a motorcycle, a bicycle, a personal mobility, an airplane, a drone, a ship, a robot, and the like.

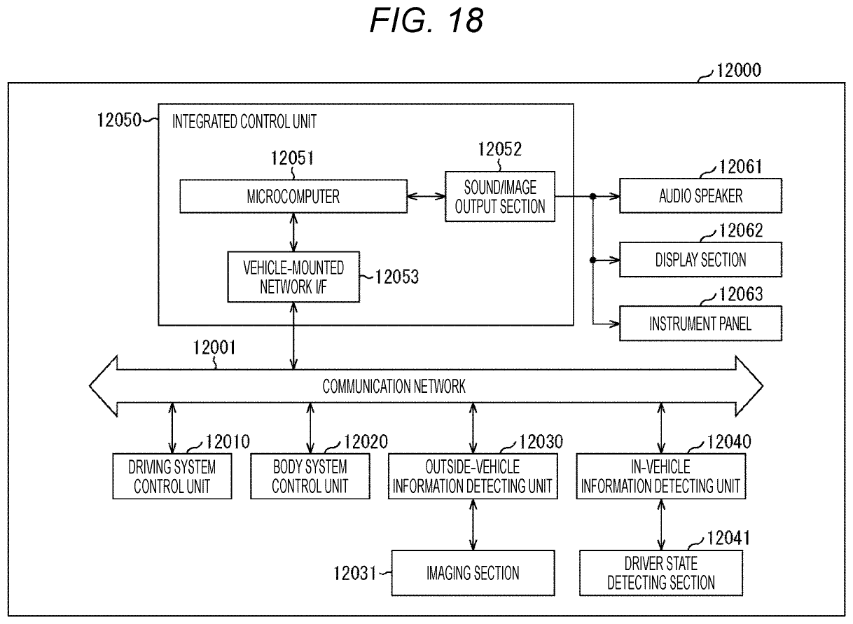

FIG. 18 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 18, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle such as an internal combustion engine or a driving motor, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information on the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device that can visually or auditorily notify an occupant or the outside of the vehicle of information. In the example in FIG. 18, an audio speaker 12061, a display section 12062, and an instrument panel 12063 are exemplified as the output device. The display section 12062 may include, for example, at least one of an on-board display or a head-up display.

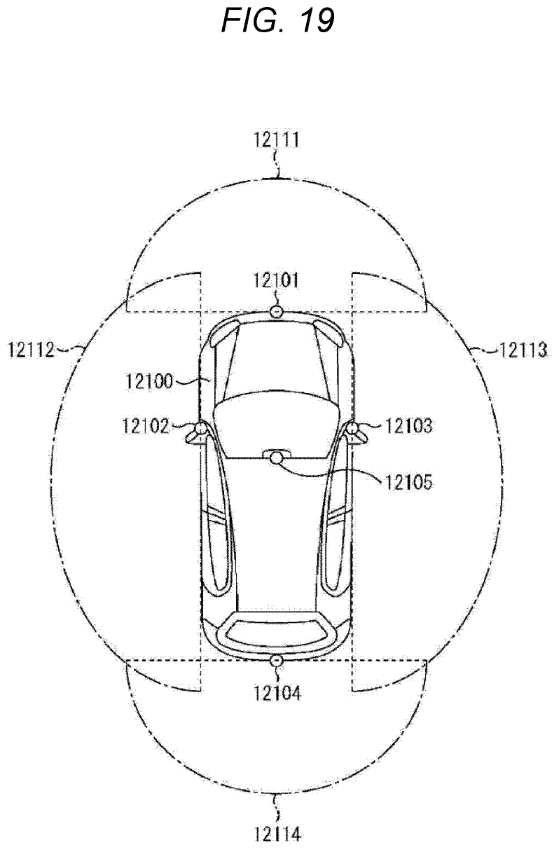

FIG. 19 is a diagram illustrating an example of an installation position of the imaging section 12031.

In FIG. 19, a vehicle 12100 includes imaging sections 12101, 12102, 12103, 12104, and 12105, as the imaging section 12031.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. Images of the front to be obtained by the imaging sections 12101 and 12105 are used mainly to detect a preceding vehicle, a pedestrian, an obstacle, a traffic signal, a traffic sign, a lane, or the like.

Note that FIG. 19 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the configurations described above. Specifically, the photodetection element 200 described above can be implemented on the imaging section 12031. Because the uniformity of the pixel characteristics is improved by applying the technology according to the present disclosure to the imaging section 12031, accurate distance information can be obtained. As a result, the functionality and safety of the vehicle 12100 can be enhanced.

Note that the present technology can also have the following configurations.
(1) A photodetection element including:
an event detection pixel that outputs, on the basis of a photocurrent obtained by photoelectrically converting incident light, a detection signal indicating that a light amount of the incident light has changed; and
an imaging pixel that is arranged adjacent to the event detection pixel and outputs a pixel signal corresponding to the light amount of the incident light on the basis of the photocurrent, in which
both the event detection pixel and the imaging pixel include
a photoelectric conversion element that photoelectrically converts the incident light,
a first pixel circuit that generates the detection signal,
a second pixel circuit that generates the pixel signal, and
a switching circuit that switches a circuit connected to the photoelectric conversion element to the first pixel circuit or the second pixel circuit.
(2) The photodetection element according to (1), in which the first pixel circuit, the second pixel circuit, and the switching circuit each have a layout of circuit elements, the layout being substantially the same between the event detection pixel and the imaging pixel.
(3) The photodetection element according to (1) or (2), in which
the switching circuit includes a switching transistor arranged between the photoelectric conversion element and the first pixel circuit, and a transfer transistor arranged between the photoelectric conversion element and the second pixel circuit, and
the switching transistor and the transfer transistor each have a layout of gate wires, the layout being substantially the same between the event detection pixel and the imaging pixel.
(4) The photodetection element according to (3), in which
in the event detection pixel, the switching transistor has a gate connected with a first gate wire, the first gate wire being connected to a power supply line, and the transfer transistor has a gate connected with a second gate wire, the second gate wire being connected to a negative potential wire, and
in the imaging pixel, the switching transistor has a gate connected with a third gate wire, the third gate wire being connected to the negative potential wire, and the transfer transistor has a gate connected with a fourth gate wire, the fourth gate wire being connected to a drive wire that transmits a pulse signal.
(5) The photodetection element according to (4), in which
the first to fourth gate wires extend in parallel to each other, and
the power supply line, the negative potential wire, and the drive wire extend in a direction intersecting the first to fourth gate wires.
(6) The photodetection element according to (3), in which,
in the event detection pixel, the switching transistor has a gate connected with a first gate wire, the first gate wire being connected to a first drive wire, and the transfer transistor has a gate connected with a second gate wire, the second gate wire being connected to a second drive wire,
in the imaging pixel, the switching transistor has a gate connected with a third gate wire, the third gate wire being connected to a third drive wire, and the transfer transistor has a gate connected with a fourth gate wire, the fourth gate wire being connected to a fourth drive wire,
the first drive wire receives input of a drive signal of a high level,
the second drive wire and the third drive wire each receive input of a drive signal of a low level, and
the fourth drive wire receives input of a pulse signal.
(7) The photodetection element according to (6), in which
the first to fourth gate wires extend in parallel to each other, and
the first to fourth drive wires extend in a direction intersecting the first to fourth gate wires.
(8) The photodetection element according to any one of (3) to (7), in which
the photodetection element is provided with a plurality of photoelectric conversion elements, a plurality of first pixel circuits, and a plurality of switching circuits for every one of a plurality of event detection pixels or a plurality of imaging pixels,
the second pixel circuit is shared by the plurality of event detection pixels or the plurality of imaging pixels, and
each of the plurality of switching circuits further includes an addition transistor that adds the photocurrent.
(9) The photodetection element according to (8), in which
the second pixel circuit includes: a floating diffusion region that accumulates electric charge of the photocurrent; a reset transistor that causes the electric charge to be released from the floating diffusion region; an amplifier transistor that generates the pixel signal on the basis of an electric charge amount of the electric charge; and a selection transistor that selects whether or not to output the pixel signal, and
the reset transistor, the amplifier transistor, and the selection transistor are dispersedly arranged in the plurality of event detection pixels or the plurality of imaging pixels.
(10) The photodetection element according to (8) or (9), in which, in one of the plurality of switching circuits provided in the plurality of event detection pixels, the switching transistor and the addition transistor are in an on state and the transfer transistor is in an off state, whereas in remaining ones of the switching circuits, the switching transistor and the addition transistor are in an off state and the transfer transistor is in an on state.
(11) The photodetection element according to any one of (8) to (10), in which, in the plurality of switching circuits provided in the plurality of imaging pixels, the switching transistor and the addition transistor are in an off state, whereas the transfer transistor is in an on state or an off state in accordance with a level of a pulse signal.
(12) The photodetection element according to any one of (8) to (11), in which the second pixel circuit is shared by event detection pixels whose number of pieces is larger than a number of pieces of imaging pixels sharing the second pixel circuit.
(13) The photodetection element according to (12), in which the plurality of imaging pixels is arranged so as to surround a pixel block to be surrounded over the entire circumference, the pixel block having the plurality of event detection pixels being aligned in a matrix.
(14) The photodetection element according to (1) or (2), in which the event detection pixel has a plurality of photoelectric conversion elements electrically connected by a diffusion layer containing n-type impurities.
(15) The photodetection element according to (2), in which the event detection pixel includes a wiring block in which a wire connected to the photoelectric conversion element is formed and a wiring block in which a wire connected to the circuit element is formed, the wiring blocks being separated by a distance, and the distance in the event detection pixel has a difference with the distance in the imaging pixel within a predetermined range.
(16) The photodetection element according to (4), in which
the power supply line has a T-shape in a portion overlapping the first gate wire and the third gate wire,
the negative potential wire has an inverted T-shape in a portion overlapping the first gate wire and the third gate wire, and
the event detection pixel includes the power supply line and the negative potential wire forming a gap at a position, the position having a difference with a position of a gap between the power supply line and the negative potential wire in the imaging pixel within a predetermined range.
(17) The photodetection element according to (4), in which
the power supply line and the negative potential wire in a peripheral region of the first gate wire each have a pattern that is different from a pattern of the power supply line and the negative potential wire in a peripheral region of the third gate wire, and
the power supply line and the negative potential wire in the peripheral region of the first gate wire are formed with a wiring density, the wiring density having a difference with a wiring density of the power supply line and the negative potential wire in the peripheral region of the third gate wire within an allowable range.
(18) An electronic apparatus including a photodetection element, the photodetection element including: an event detection pixel that outputs, on the basis of a photocurrent obtained by photoelectrically converting incident light, a detection signal indicating that a light amount of the incident light has changed; and an imaging pixel that is arranged adjacent to the event detection pixel and outputs a pixel signal corresponding to the light amount of the incident light on the basis of the photocurrent, in which
both the event detection pixel and the imaging pixel include
a photoelectric conversion element that photoelectrically converts the incident light,
a first pixel circuit that generates the detection signal,
a second pixel circuit that generates the pixel signal, and
a switching circuit that switches a circuit connected to the photoelectric conversion element to the first pixel circuit or the second pixel circuit.

### REFERENCE SIGNS LIST

100 Electronic apparatus
200 Photodetection element
301a to 307a Event detection pixel
301b to 307b Imaging pixel
310, 310a to 310d Photoelectric conversion element
311 First pixel circuit
312, 313, 315, 316 MOS transistor
320 Second pixel circuit
321 Reset transistor
322 Floating diffusion region
323 Amplifier transistor
324 Selection transistor
330 Switching circuit
331 Switching transistor
332 Transfer transistor
333 Addition transistor
350 Diffusion layer
M11 First gate wire
M12 Second gate wire
M13 Third gate wire
M14 Fourth gate wire
TG1 First drive wire
TG2 Second drive wire
TG3 Third drive wire
TG4 Fourth drive wire
VDD Power supply line
VSS Negative potential wire

1. A photodetection element comprising:
an event detection pixel that outputs, on a basis of a photocurrent obtained by photoelectrically converting incident light, a detection signal indicating that a light amount of the incident light has changed; and
an imaging pixel that is arranged adjacent to the event detection pixel and outputs a pixel signal corresponding to the light amount of the incident light on a basis of the photocurrent, wherein
both the event detection pixel and the imaging pixel include
a photoelectric conversion element that photoelectrically converts the incident light,
a first pixel circuit that generates the detection signal,
a second pixel circuit that generates the pixel signal, and
a switching circuit that switches a circuit connected to the photoelectric conversion element to the first pixel circuit or the second pixel circuit.

2. The photodetection element according to claim 1, wherein the first pixel circuit, the second pixel circuit, and the switching circuit each have a layout of circuit elements, the layout being substantially a same between the event detection pixel and the imaging pixel.

3. The photodetection element according to claim 1, wherein
the switching circuit includes a switching transistor arranged between the photoelectric conversion element and the first pixel circuit, and a transfer transistor arranged between the photoelectric conversion element and the second pixel circuit, and
the switching transistor and the transfer transistor each have a layout of gate wires, the layout being substantially a same between the event detection pixel and the imaging pixel.

4. The photodetection element according to claim 3, wherein,
in the event detection pixel, the switching transistor has a gate connected with a first gate wire, the first gate wire being connected to a power supply line, and the transfer transistor has a gate connected with a second gate wire, the second gate wire being connected to a negative potential wire, and
in the imaging pixel, the switching transistor has a gate connected with a third gate wire, the third gate wire being connected to the negative potential wire, and the transfer transistor has a gate connected with a fourth gate wire, the fourth gate wire being connected to a drive wire that transmits a pulse signal.

5. The photodetection element according to claim 4, wherein
the first to fourth gate wires extend in parallel to each other, and
the power supply line, the negative potential wire, and the drive wire extend in a direction intersecting the first to fourth gate wires.

6. The photodetection element according to claim 3, wherein,
in the event detection pixel, the switching transistor has a gate connected with a first gate wire, the first gate wire being connected to a first drive wire, and the transfer transistor has a gate connected with a second gate wire, the second gate wire being connected to a second drive wire,
in the imaging pixel, the switching transistor has a gate connected with a third gate wire, the third gate wire being connected to a third drive wire, and the transfer transistor has a gate connected with a fourth gate wire, the fourth gate wire being connected to a fourth drive wire,
the first drive wire receives input of a drive signal of a high level,
the second drive wire and the third drive wire each receive input of a drive signal of a low level, and
the fourth drive wire receives input of a pulse signal.

7. The photodetection element according to claim 6, wherein
the first to fourth gate wires extend in parallel to each other, and
the first to fourth drive wires extend in a direction intersecting the first to fourth gate wires.

8. The photodetection element according to claim 3, wherein
the photodetection element is provided with a plurality of photoelectric conversion elements, a plurality of first pixel circuits, and a plurality of switching circuits for every one of a plurality of event detection pixels or a plurality of imaging pixels,
the second pixel circuit is shared by the plurality of event detection pixels or the plurality of imaging pixels, and
each of the plurality of switching circuits further includes an addition transistor that adds the photocurrent.

9. The photodetection element according to claim 8, wherein
the second pixel circuit includes: a floating diffusion region that accumulates electric charge of the photocurrent; a reset transistor that causes the electric charge to be released from the floating diffusion region; an amplifier transistor that generates the pixel signal on a basis of an electric charge amount of the electric charge; and a selection transistor that selects whether or not to output the pixel signal, and
the reset transistor, the amplifier transistor, and the selection transistor are dispersedly arranged in the plurality of event detection pixels or the plurality of imaging pixels.

10. The photodetection element according to claim 8, wherein, in one of the plurality of switching circuits provided in the plurality of event detection pixels, the switching transistor and the addition transistor are in an on state and the transfer transistor is in an off state, whereas in remaining ones of the switching circuits, the switching transistor and the addition transistor are in an off state and the transfer transistor is in an on state.

11. The photodetection element according to claim 8, wherein, in the plurality of switching circuits provided in the plurality of imaging pixels, the switching transistor and the addition transistor are in an off state, whereas the transfer transistor is in an on state or an off state in accordance with a level of a pulse signal.

12. The photodetection element according to claim 8, wherein the second pixel circuit is shared by event detection pixels whose number of pieces is larger than a number of pieces of imaging pixels sharing the second pixel circuit.

13. The photodetection element according to claim 12, wherein the plurality of imaging pixels is arranged so as to surround a pixel block over an entire circumference, the pixel block having the plurality of event detection pixels being aligned in a matrix.

14. The photodetection element according to claim 1, wherein the event detection pixel has a plurality of photoelectric conversion elements electrically connected by a diffusion layer containing n-type impurities.

15. The photodetection element according to claim 2, wherein the event detection pixel includes a wiring block in which a wire connected to the photoelectric conversion element is formed and a wiring block in which a wire connected to the circuit element is formed, the wiring blocks being separated by a distance, and the distance in the event detection pixel has a difference with the distance in the imaging pixel within a predetermined range.

16. The photodetection element according to claim 4, wherein
the power supply line has a T-shape in a portion overlapping the first gate wire and the third gate wire,
the negative potential wire has an inverted T-shape in a portion overlapping the first gate wire and the third gate wire, and
the event detection pixel includes the power supply line and the negative potential wire forming a gap at a position, the position having a difference with a position of a gap between the power supply line and the negative potential wire in the imaging pixel within a predetermined range.

17. The photodetection element according to claim 4, wherein
the power supply line and the negative potential wire in a peripheral region of the first gate wire each have a pattern that is different from a pattern of the power supply line and the negative potential wire in a peripheral region of the third gate wire, and
the power supply line and the negative potential wire in the peripheral region of the first gate wire are formed with a wiring density, the wiring density having a difference with a wiring density of the power supply line and the negative potential wire in the peripheral region of the third gate wire within an allowable range.

18. An electronic apparatus comprising a photodetection element, the photodetection element including: an event detection pixel that outputs, on a basis of a photocurrent obtained by photoelectrically converting incident light, a detection signal indicating that a light amount of the incident light has changed; and an imaging pixel that is arranged adjacent to the event detection pixel and outputs a pixel signal corresponding to the light amount of the incident light on a basis of the photocurrent, wherein
both the event detection pixel and the imaging pixel include
a photoelectric conversion element that photoelectrically converts the incident light,
a first pixel circuit that generates the detection signal,
a second pixel circuit that generates the pixel signal, and
a switching circuit that switches a circuit connected to the photoelectric conversion element to the first pixel circuit or the second pixel circuit.
